(19) United States
(12) Patent Application Publication
(10) Pub. No.: US 2021/0073315 A1
(43) Pub. Date: Mar. 11, 2021

(54) SYSTEM FOR COMPUTING RESOURCE VALUATION USING A GRAPHICS PROCESSING UNIT-BASED DISCRETE FOURIER TRANSFORM ALGORITHM

(71) Applicant: Bank of America Corporation, Charlotte, NC (US)

(72) Inventor: Enming Zhou, Thousand Oaks, CA (US)

(73) Assignee: Bank of America Corporation, Charlotte, NC (US)

(21) Appl. No.: 16/561,222

(22) Filed: Sep. 5, 2019

(51) Int. Cl. G06F 17/14; G06F 17/15

(52) U.S. Cl. CPC G06F 17/142; G06F 17/15

(57) ABSTRACT

A system provides for computing resource valuation using a graphics processing unit-based discrete Fourier transform algorithm. The system may, via DFT, transform resource valuation equations into their constituent operations, which may in turn be resolved in parallel using a multi-core graphics processing unit. In this way, the system may allow for highly expedient and efficient resolution of resource valuation calculations.

### FIELD OF THE INVENTION

The present disclosure embraces a system for computing resource valuation using a graphics processing unit-based discrete Fourier transform algorithm.

### BACKGROUND

Conventional methods of computing certain types of complex resource valuations may be an inefficient, time-intensive process. Accordingly, there is a need for an expedient and efficient way to perform computations of complex resource valuations.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present disclosure is directed to a system for computing resource valuation using a graphics processing unit-based discrete Fourier transform algorithm. The system may, via DFT, transform resource valuation equations into their constituent operations, which may in turn be resolved in parallel using a multi-core graphics processing unit. In this way, the system may allow for highly expedient and efficient resolution of resource valuation calculations.

Accordingly, embodiments of the present disclosure provide a system for computing resource valuation using a multi-core processing unit. The system may comprise a memory device with computer-readable program code stored thereon; a communication device; and a processing device operatively coupled to the memory device and the communication device. The processing device may be configured to execute the computer-readable program code to identify a complex equation for computation; perform a first set of operations to the complex equation to produce a transformed equation, the first set of operations comprising discrete Fourier transform of the complex equation; perform a second set of operations to the transformed equation, the second set of operations comprising generating an implementation of the transformed equation; compute the implementation of the transformed equation via the multi-core processing unit; and receive a complex equation output from the multi-core processing unit.

In some embodiments, the discrete Fourier transform of the complex equation comprises an inverse fast Fourier transform of one or more terms within the complex equation.

In some embodiments, the discrete Fourier transform of the complex equation comprises a forward fast Fourier transform of one or more terms within the complex equation.

In some embodiments, the discrete Fourier transform of the complex equation comprises a fast Fourier transform convolution of one or more terms within the complex equation.

In some embodiments, generating an implementation of the transformed equation comprises accessing a software library to create an instruction set capable of being processed by the multi-core processing unit.

In some embodiments, computing the implementation of the transformed equation comprises resolving the equation in parallel across a plurality of processing cores of the multi-core processing unit.

In some embodiments, the multi-core processing unit is a graphics processing unit.

Embodiments of the present disclosure also provide a computer program product for computing resource valuation using a multi-core processing unit. The computer program product may comprise at least one non-transitory computer readable medium having computer-readable program code portions embodied therein, the computer-readable program code portions comprising executable code portions for identifying a complex equation for computation; performing a first set of operations to the complex equation to produce a transformed equation, the first set of operations comprising discrete Fourier transform of the complex equation; performing a second set of operations to the transformed equation, the second set of operations comprising generating an implementation of the transformed equation; computing the implementation of the transformed equation via the multi-core processing unit; and receiving a complex equation output from the multi-core processing unit.

In some embodiments, the discrete Fourier transform of the complex equation comprises an inverse fast Fourier transform of one or more terms within the complex equation.

In some embodiments, the discrete Fourier transform of the complex equation comprises a forward fast Fourier transform of one or more terms within the complex equation.

In some embodiments, the discrete Fourier transform of the complex equation comprises a fast Fourier transform convolution of one or more terms within the complex equation.

In some embodiments, generating an implementation of the transformed equation comprises accessing a software library to create an instruction set capable of being processed by the multi-core processing unit.

In some embodiments, computing the implementation of the transformed equation comprises resolving the equation in parallel across a plurality of processing cores of the multi-core processing unit.

Embodiments of the present disclosure also provide a computer-implemented method for computing resource valuation using a multi-core processing unit. The method may comprise identifying a complex equation for computation; performing a first set of operations to the complex equation to produce a transformed equation, the first set of operations comprising discrete Fourier transform of the complex equation; performing a second set of operations to the transformed equation, the second set of operations comprising generating an implementation of the transformed equation; computing the implementation of the transformed equation via the multi-core processing unit; and receiving a complex equation output from the multi-core processing unit.

In some embodiments, the discrete Fourier transform of the complex equation comprises an inverse fast Fourier transform of one or more terms within the complex equation.

In some embodiments, the discrete Fourier transform of the complex equation comprises a forward fast Fourier transform of one or more terms within the complex equation.

In some embodiments, the discrete Fourier transform of the complex equation comprises a fast Fourier transform convolution of one or more terms within the complex equation.

In some embodiments, generating an implementation of the transformed equation comprises accessing a software library to create an instruction set capable of being processed by the multi-core processing unit.

In some embodiments, computing the implementation of the transformed equation comprises resolving the equation in parallel across a plurality of processing cores of the multi-core processing unit.

In some embodiments, the multi-core processing unit is a graphics processing unit.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the resource valuation computation system, in accordance with one embodiment of the present disclosure; and

FIG. 2 illustrates a process flow for the resource valuation computation, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices, systems, and/or peripheral devices on which the system described herein is implemented. The entity may be a business organization, a non-profit organization, a government organization, and the like, which may routinely use various types of applications within its enterprise environment to accomplish its organizational objectives.

“Entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“Computing system” or “computing device” as used herein may refer to a networked computing device within the entity system. The computing system may include a processor, a non-transitory storage medium, a communications device, and a display. The computing system may be configured to support user logins and inputs from any combination of similar or disparate devices. Accordingly, the computing system may be a portable electronic device such as a smartphone, tablet, single board computer, smart device, or laptop. In other embodiments, the computing system may be a stationary unit such as a personal desktop computer, networked terminal, IoT device, or the like.

“User” as used herein may refer to an individual who may interact with the entity system to access the functions therein. Accordingly, the user may be an agent, employee, associate, contractor, or other authorized party who may access, use, administrate, maintain, and/or manage the computing systems within the entity system. In other embodiments, the user may be a client or customer of the entity.

Accordingly, as used herein the term “user device” or “mobile device” may refer to mobile phones, personal computing devices, tablet computers, wearable devices, and/or any portable electronic device capable of receiving and/or storing data therein.

“Resource” as used herein may refer to an object under the ownership of a user which is stored or maintained by the entity on the user's behalf. The resource may be intangible or tangible objects such as data files, documents, biographical data, funds, and the like. Typically, the user's account contains records of the resources owned by the user. Accordingly, account data may be stored in an account database within the entity's systems.

Embodiments of the present disclosure provide a system for computing resource valuation using a graphics processing unit (“GPU”) and discrete Fourier transform (“DFT”) algorithm. In particular, the system (e.g., a “resource valuation computation system”) may allow for the transformation (e.g., via one or more operations, such as DFT) of complex equations into multiple constituent component operations. The constituent operations may then be translated (e.g., via a subprogram or subprocess library) into code that may be executed by one or more multi-core processing unit (e.g., graphics processing units) in parallel to produce a resolution output of the complex equation.

An exemplary embodiment is provided below for illustrative purposes; it should be understood that the following description is not intended to restrict the scope of the disclosure. In one embodiment, the complex equation to be computed may be an equation to calculate the net present value of an asset for a given period, as shown below:

$$P V = {\sum }_{t = i}^{T} \frac{{C}_{t}}{{( 1 + {r}_{t} )}^{t}} ,$$

where PV is the present value, C is the cashflow payment, t is the time, and r is the interest rate. In order to account for rates that may change over time, the system may compute present value using every possible interest rate scenario for the given period. In this regard, the system may begin by expressing the vector of present values Pᵢ using the following equation:

Pᵢ=C_{N}*R_{N}.

where Pᵢ is the vector of present values for various different interest rate scenarios, C_{N} represents the cashflow vector, and R_{N} represents the interest rate vector.

The system may then transform the above equation using a series of operations and processes to implement the computation of the present value for different interest rate scenarios. In particular, in some embodiments, the series of operations and processes may include DFT operations and/or fast Fourier transform (“FFT”) operations. Generally, DFT converts a finite sequence of equally-spaced samples of a function (e.g., a time function) into a complex-valued function of frequency. Accordingly, the system may apply an inverse Fourier transform (F⁻¹) on both sides of the above equation to reach the following equation:

F⁻¹(Pₗ)=F⁻¹(C_{N}*R_{N}).

To the above equation, the system may apply the following DFT equations:

[symbol]

⁻¹(a [symbol] b)=n [symbol] ⁻¹(a) [symbol] ⁻¹(b)

and

[symbol]

⁻¹( [symbol] (a))= [symbol] ( [symbol] ⁻¹(a))=a

to reach:

F⁻¹(Pᵢ)=F⁻¹(C_{N})*(\sqrt{N}F(R_{N})).

By applying forward Fourier transform to both sides and by using the DFT equations above, the system may reach:

Pᵢ=F(F⁻¹(C_{N})*(\sqrt{N}F(R_{N}))).

where Pᵢ is the current present value when i=0.

In some embodiments, the system may apply FFT to the above equation, where FFT is an algorithm for computing DFT, where the algorithm is O (N log N), where N is the data size. At this stage, the system may use one or more software libraries (e.g., subprocess and/or subprogram libraries) to implement the present value equation transformed via DFT/FFT on a multi-core processing unit, where the processing cores may be used to compute the present value vectors according to the DFT-transformed present value equation as described above and elsewhere herein. In an exemplary embodiment, the DFT-transformed equation may be implemented on the processing cores of a graphics processing unit using the a software platform which may comprise one or more software libraries and/or API's. In such embodiments, the software libraries comprises the code necessary to perform the computations of the DFT-transformed equations across all of the processing cores of the GPU, where the cores may number in the thousands.

The system as described herein confers a number of technological advantages over conventional systems for performing computations. By applying DFT/FFT algorithms and implementing the algorithms on multi-core processing units (e.g., GPU's), the system may reduce the time needed to compute complex mathematical calculations by orders of magnitude. In turn, the drastic computation speed improvement may increase the efficiency of all computing systems which depend on the outputs produced by the process described herein.

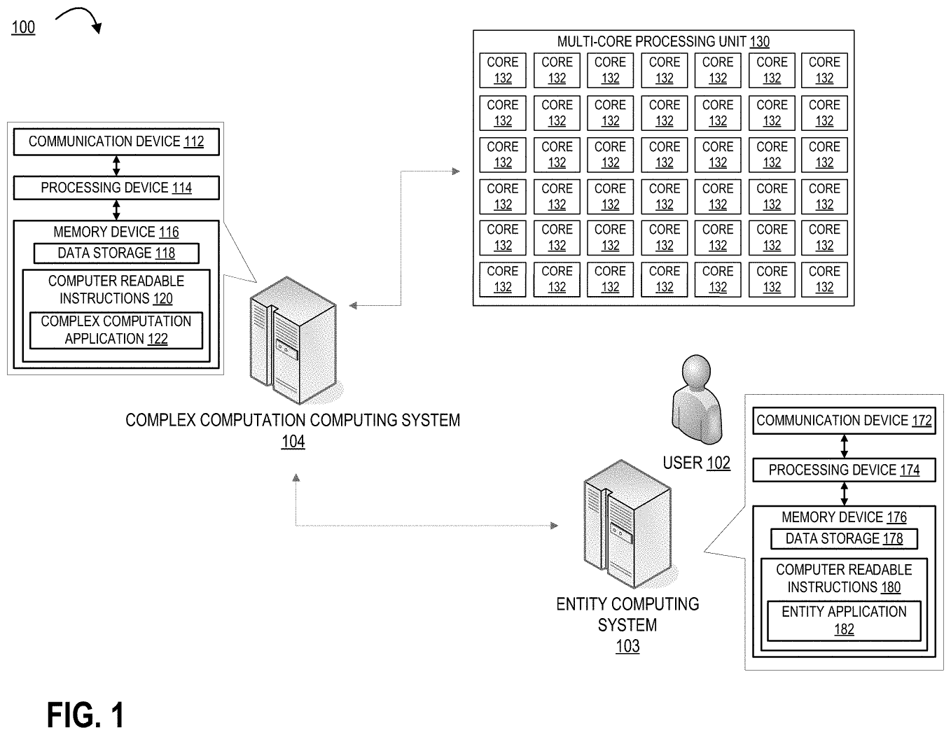

Turning now to the figures, FIG. 1 illustrates an operating environment 100 for the resource valuation computation system, in accordance with one embodiment of the present disclosure. In particular, FIG. 1 illustrates a complex computation computing system 104 that is operatively coupled, via a network, to a multi-core processing unit 130 and/or an entity computing system 103. In such a configuration, the complex computation computing system 104 may transmit information to and receive information from the multi-core processing unit 130 and/or the entity computing system 103. It should be understood that FIG. 1 illustrates only an exemplary embodiment of the operating environment 100, and it will be appreciated that one or more functions of the systems, devices, or servers as depicted in FIG. 1 may be combined into a single system, device, or server. For instance, though the complex computation computing system 104 and the multi-core processing unit 130 are depicted separately, the functions and processes of the complex computation computing system 104 and multi-core processing unit 130 may be executed within a single computing system. Furthermore, a single system, device, or server as depicted in FIG. 1 may represent multiple systems, devices, or servers. For instance, though the multi-core processing unit 130 is depicted as a single unit, the system may comprise multiple multi-core processing units 130 operating in parallel with one another.

The network may be a system specific distributive network receiving and -distributing specific network feeds and identifying specific network associated triggers. The network include one or more cellular radio towers, antennae, cell sites, base stations, telephone networks, cloud networks, radio access networks (RAN), WiFi networks, or the like. Additionally, the network may also include a global area network (GAN), such as the Internet, a wide area network (WAN), a local area network (LAN), or any other type of network or combination of networks. Accordingly, the network may provide for wireline, wireless, or a combination wireline and wireless communication between devices on the network.

The complex computation computing system 104 as depicted in FIG. 1 may be a computing system within the entity system which provides for the computation of complex equations as described herein. Accordingly, the complex computation computing system 104 may comprise a communication device 112, a processing device 114, and a memory device 116, where the processing device 114 is operatively coupled to the communication device 112 and the memory device 116. The processing device 114 uses the communication device 112 to communicate with the network and other devices on the network, such as, but not limited to the the entity computing system 103. As such, the communication device 112 generally comprises a modem, antennae, WiFi or Ethernet adapter, radio transceiver, or other device for communicating with other devices on the network.

As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The memory device 116 comprises computer-readable instructions 120 and data storage 118, which in one embodiment includes the computer-readable instructions 120 of a complex computation application 122. The complex computation application 122 may comprise executable code for causing the processing device 114 to perform a series of operations to transform certain equations and/or processes (e.g., via DFT, FFT, or the like) into a format that is capable of being processed by the multi-core processing unit 130. Accordingly, the complex computation application 122 may provide an input (e.g., the transformed equation) to the multi-core processing unit 130 and/or receive outputs (e.g., the computed real or complex values) from the multi-core processing unit 130.

The multi-core processing unit 130 as depicted in FIG. 1 may refer to a device or hardware unit comprising one or more processing cores 132. It should be understood that while FIG. 1 depicts the multi-core processing unit 130 as having 42 processing cores 132, the multi-core processing unit 130 may have fewer or more processing cores 132 (e.g., numbering in the thousands) depending on the identity of the multi-core processing unit 130. The multi-core processing unit 130 may use an architecture which allows for code and/or algorithms to be computed and/or processed on its processing cores 132 in parallel. In this regard, the multi-core processing unit 130 may support inputs from the complex computation computing system 104 via an API. In some embodiments, the multi-core processing unit 130 may be a device such as a graphics processing unit. In such embodiments, the operations and processes to transform the complex equation may include operations to implement the transformed equation using the software library and API.

The entity computing system 103 as depicted in FIG. 1 may refer to a computing system which may be operated by a user 102 such as an agent or administrator of the entity. The user 102 may use the entity computing system 103 to access the outputs of the transformed algorithm (e.g., the outputs produced by the multi-core processing unit 130) by connecting to the complex computation computing system 104. Accordingly, the entity computing system 103 may comprise a processing device 174 operatively coupled to the communication device 172 and a memory device 176 comprising data storage 178 and computer readable instructions 180. The computer readable instructions 180 may comprise an entity application 182 which may be configured to instruct the processing device 174 to execute certain functions over the network, such as interacting with the complex computation computing system 104.

The communication device 172, and other communication devices as described herein, may comprise a wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. Alternatively or in addition to the wireless interface, the entity computing system 103 may also include a communication interface device that may be connected by a hardwire connection to the resource distribution device. The interface device may comprise a connector such as a USB, SATA, PATA, SAS or other data connector for transmitting data to and from the respective computing system.

The computing systems described herein may each further include a processing device communicably coupled to devices as a memory device, output devices, input devices, a network interface, a power source, a clock or other timer, a camera, a positioning system device, a gyroscopic device, one or more chips, and the like.

In some embodiments, the computing systems may access one or more databases or datastores (not shown) to search for and/or retrieve information related to the service provided by the entity. The computing systems may also access a memory and/or datastore local to the various computing systems within the operating environment 100.

The processing devices as described herein may include functionality to operate one or more software programs or applications, which may be stored in the memory device. For example, a processing device may be capable of operating a connectivity program, such as a web browser application. In this way, the computing systems may transmit and receive web content, such as, for example, product valuation, service agreements, location-based content, and/or other web page content, according to a Wireless Application Protocol (WAP), Hypertext Transfer Protocol (HTTP), and/or the like.

A processing device may also be capable of operating applications. The applications may be downloaded from a server and stored in the memory device of the computing systems. Alternatively, the applications may be pre-installed and stored in a memory in a chip.

The chip may include the necessary circuitry to provide integration within the devices depicted herein. Generally, the chip will include data storage which may include data associated with the service that the computing systems may be communicably associated therewith. The chip and/or data storage may be an integrated circuit, a microprocessor, a system-on-a-chip, a microcontroller, or the like. In this way, the chip may include data storage. Of note, it will be apparent to those skilled in the art that the chip functionality may be incorporated within other elements in the devices. For instance, the functionality of the chip may be incorporated within the memory device and/or the processing device. In a particular embodiment, the functionality of the chip is incorporated in an element within the devices. Still further, the chip functionality may be included in a removable storage device such as an SD card or the like.

A processing device may be configured to use the network interface to communicate with one or more other devices on a network. In this regard, the network interface may include an antenna operatively coupled to a transmitter and a receiver (together a “transceiver”). The processing device may be configured to provide signals to and receive signals from the transmitter and receiver, respectively. The signals may include signaling information in accordance with the air interface standard of the applicable cellular system of the wireless telephone network that may be part of the network. In this regard, the computing systems may be configured to operate with one or more air interface standards, communication protocols, modulation types, and access types. By way of illustration, the devices may be configured to operate in accordance with any of a number of first, second, third, fourth, and/or fifth-generation communication protocols and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, or the like. The devices may also be configured to operate in accordance with non-cellular communication mechanisms, such as via a wireless local area network (WLAN) or other communication/data networks.

The network interface may also include an application interface in order to allow a user or service provider to execute some or all of the above-described processes. The application interface may have access to the hardware, e.g., the transceiver, and software previously described with respect to the network interface. Furthermore, the application interface may have the ability to connect to and communicate with an external data storage on a separate system within the network.

The devices may have an interface that includes user output devices and/or input devices. The output devices may include a display (e.g., a liquid crystal display (LCD) or the like) and a speaker or other audio device, which are operatively coupled to the processing device. The input devices, which may allow the devices to receive data from a user 102, may include any of a number of devices allowing the devices to receive data from a user 102, such as a keypad, keyboard, touch-screen, touchpad, microphone, mouse, joystick, other pointer device, button, soft key, and/or other input device(s).

The devices may further include a power source. Generally, the power source is a device that supplies electrical energy to an electrical load. In some embodiment, power source may convert a form of energy such as solar energy, chemical energy, mechanical energy, or the like to electrical energy. Generally, the power source may be a battery, such as a lithium battery, a nickel-metal hydride battery, or the like, that is used for powering various circuits, e.g., the transceiver circuit, and other devices that are used to operate the devices. Alternatively, the power source may be a power adapter that can connect a power supply from a power outlet to the devices. In such embodiments, a power adapter may be classified as a power source “in” the devices.

As described above, the computing devices as shown in FIG. 1 may also include a memory device operatively coupled to the processing device. As used herein, “memory” may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the devices described herein.

The computing systems may further comprise a gyroscopic device. The positioning system, input device, and the gyroscopic device may be used in correlation to identify phases within a service term.

Each computing system may also have a control system for controlling the physical operation of the device. The control system may comprise one or more sensors for detecting operating conditions of the various mechanical and electrical systems that comprise the computing systems or of the environment in which the computing systems are used. The sensors may communicate with the processing device to provide feedback to the operating systems of the device. The control system may also comprise metering devices for measuring performance characteristics of the computing systems. The control system may also comprise controllers such as programmable logic controllers (PLC), proportional integral derivative controllers (PID) or other machine controllers. The computing systems may also comprise various electrical, mechanical, hydraulic or other systems that perform various functions of the computing systems. These systems may comprise, for example, electrical circuits, motors, compressors, or any system that enables functioning of the computing systems.

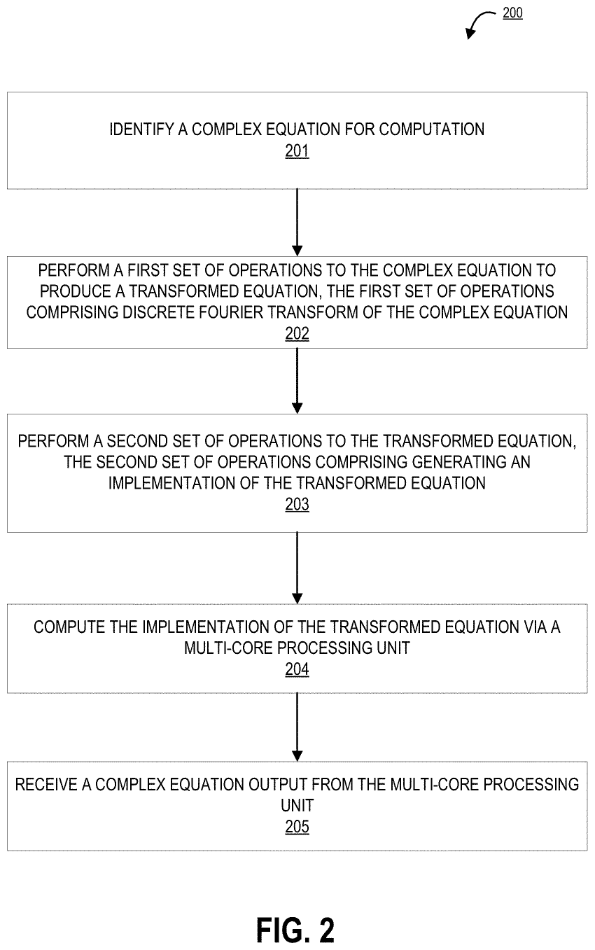

FIG. 2 illustrates a process flow 200 for the resource valuation computation system, in accordance with one embodiment of the present disclosure. The process begins at block 201, where the system identifies a complex equation for computation. The complex equation may be an equation that may be most efficiently calculated in parallel using a processing device having multiple processing cores (e.g., a multi-core processing device). Accordingly, in some embodiments, the multi-core processing device may be a graphics processing unit which may have thousands of processing cores. In an exemplary embodiment, the complex equation for computation may be an equation to determine net present value of an asset. In such an embodiment, the system may execute a series of operations to implement the computation of the net present value equation Pᵢ=C_{N}*R_{N} on the multi-core processing unit, as will be explained in further detail below.

The process continues to block 202, where the system performs a first set of operations to the complex equation to produce a transformed equation, the first set of operations comprising discrete Fourier transform. In particular, the system may use fast Fourier transform to perform the DFT computations on the complex equation. Continuing the above example, the first set of operations may begin with an inverse FFT computation on cashflow vector C_{N}, which may be expressed as F⁻¹(C_{N}), and a forward FFT computation on discount factor vector R_{N}, which may be expressed as F(R_{N}), which may in turn be adjusted into (\sqrt{N} F(R_{N})). The system may then perform an FFT convolution of the equation to reach (F⁻¹(C_{N}))*(\sqrt{N} F(R_{N})). Finally, the system may perform an FFT of the above equation to reach the transformed equation F(F⁻¹(C_{N}))*(\sqrt{N} F (R_{N})).

The process continues to block 203, where the system performs a second set of operations to the transformed equation, the second set of operations comprising generating an implementation of the transformed equation. In particular, the system may use a toolkit (which may include an API, subprocess library, software layer, or the like) to implement the transformed equation into an instruction set readable by the multi-core processing device. In such scenarios, the instruction set may allow the multi-core processing device to perform resolution of the transformed equation in parallel across some or all of the processing cores of the multi-core processing device.

The process continues to block 204, where the system computes the implementation of the transformed equation via the multi-core processing unit. As described above, the implementation of the transformed equation may allow the processing cores of the multi-core processing unit to compute the solution of the equation in parallel. By using the plurality of processing cores to perform the computations in this manner, the system may allow complex computations to be resolved hundreds or thousands of times faster compared to conventional computation methods.

The process concludes at block 205, where the system receives a complex equation output from the multi-core processing unit. The complex equation output may comprise the solution to the complex equation. Continuing the above example, the complex equation output may comprise the computed net present value of the asset, which may take into account all interest rate scenarios for the asset. In this way, the system may provide an efficient and expedient way to perform complex computations that would otherwise be inefficient or impracticable to compute via conventional methods.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for computing resource valuation using a multi-core processing unit, the system comprising:
a memory device with computer-readable program code stored thereon;
a communication device; and
a processing device operatively coupled to the memory device and the communication device, wherein the processing device is configured to execute the computer-readable program code to:
identify a complex equation for computation;
perform a first set of operations to the complex equation to produce a transformed equation, the first set of operations comprising discrete Fourier transform of the complex equation;
perform a second set of operations to the transformed equation, the second set of operations comprising generating an implementation of the transformed equation;
compute the implementation of the transformed equation via the multi-core processing unit; and
receive a complex equation output from the multi-core processing unit.

2. The system according to claim 1, wherein the discrete Fourier transform of the complex equation comprises an inverse fast Fourier transform of one or more terms within the complex equation.

3. The system according to claim 1, wherein the discrete Fourier transform of the complex equation comprises a forward fast Fourier transform of one or more terms within the complex equation.

4. The system according to claim 1, wherein the discrete Fourier transform of the complex equation comprises a fast Fourier transform convolution of one or more terms within the complex equation.

5. The system according to claim 1, wherein generating an implementation of the transformed equation comprises accessing a software library to create an instruction set capable of being processed by the multi-core processing unit.

6. The system according to claim 1, wherein computing the implementation of the transformed equation comprises resolving the equation in parallel across a plurality of processing cores of the multi-core processing unit.

7. The system according to claim 1, wherein the multi-core processing unit is a graphics processing unit.

8. A computer program product for computing resource valuation using a multi-core processing unit, the computer program product comprising at least one non-transitory computer readable medium having computer-readable program code portions embodied therein, the computer-readable program code portions comprising executable code portions for:
identifying a complex equation for computation;
performing a first set of operations to the complex equation to produce a transformed equation, the first set of operations comprising discrete Fourier transform of the complex equation;
performing a second set of operations to the transformed equation, the second set of operations comprising generating an implementation of the transformed equation;
computing the implementation of the transformed equation via the multi-core processing unit; and
receiving a complex equation output from the multi-core processing unit.

9. The computer program product according to claim 8, wherein the discrete Fourier transform of the complex equation comprises an inverse fast Fourier transform of one or more terms within the complex equation.

10. The computer program product according to claim 8, wherein the discrete Fourier transform of the complex equation comprises a forward fast Fourier transform of one or more terms within the complex equation.

11. The computer program product according to claim 8, wherein the discrete Fourier transform of the complex equation comprises a fast Fourier transform convolution of one or more terms within the complex equation.

12. The computer program product according to claim 8, wherein generating an implementation of the transformed equation comprises accessing a software library to create an instruction set capable of being processed by the multi-core processing unit.

13. The computer program product according to claim 8, wherein computing the implementation of the transformed equation comprises resolving the equation in parallel across a plurality of processing cores of the multi-core processing unit.

14. A computer-implemented method for computing resource valuation using a multi-core processing unit, the method comprising:
identifying a complex equation for computation;
performing a first set of operations to the complex equation to produce a transformed equation, the first set of operations comprising discrete Fourier transform of the complex equation;
performing a second set of operations to the transformed equation, the second set of operations comprising generating an implementation of the transformed equation;
computing the implementation of the transformed equation via the multi-core processing unit; and
receiving a complex equation output from the multi-core processing unit.

15. The computer-implemented method of claim 14, wherein the discrete Fourier transform of the complex equation comprises an inverse fast Fourier transform of one or more terms within the complex equation.

16. The computer-implemented method of claim 14, wherein the discrete Fourier transform of the complex equation comprises a forward fast Fourier transform of one or more terms within the complex equation.

17. The computer-implemented method of claim 14, wherein the discrete Fourier transform of the complex equation comprises a fast Fourier transform convolution of one or more terms within the complex equation.

18. The computer-implemented method of claim 14, wherein generating an implementation of the transformed equation comprises accessing a software library to create an instruction set capable of being processed by the multi-core processing unit.

19. The computer-implemented method of claim 14, wherein computing the implementation of the transformed equation comprises resolving the equation in parallel across a plurality of processing cores of the multi-core processing unit.

20. The computer-implemented method of claim 14, wherein the multi-core processing unit is a graphics processing unit.
